(19) United States
(12) Patent Application Publication
(10) Pub. No.: US 2021/0378054 A1
(43) Pub. Date: Dec. 2, 2021

(54) SPATIAL REUSE (SR) FOR OFDMA TRANSMISSIONS IN WLAN SYSTEMS

(71) Applicant: QUALCOMM Incorporated, San Diego, CA (US)

(72) Inventors: Vinod BELUR RAMACHANDRA, Chennai (IN); Abhijit BHATTACHARYA, Bangalore (IN); Mani Bharathi PANDIAN, Santa Clara, CA (US); Arul Durai Murugan PALANIVELU, Bangalore (IN)

(21) Appl. No.: 16/884,364

(22) Filed: May 27, 2020

(51) Int. Cl. H04W 84/12; H04W 72/08; H04W 52/02; H04L 5/00; H04L 1/16

(52) U.S. Cl. CPC H04W 84/12; H04W 72/082; H04L 1/1685; H04L 5/0007; H04W 52/0222

(57) ABSTRACT

This disclosure provides systems, methods and apparatus, including computer programs encoded on computer storage media, for spatial reuse in a wireless network. In an example method, a first wireless device detects an overlapping basic service set (OBSS) packet received from a second wireless device in an OBSS, decodes one or more signal fields of the OBSS packet, determines that the OBSS packet is a transmission in which one or more resource unit (RUs) are unallocated, and performs a spatial reuse (SR) transmission to one or more first stations using a number of the unallocated RUs.

### TECHNICAL FIELD

This disclosure relates generally to wireless networks, and more specifically, to spatial reuse for overlapping basic service sets (OBSS).

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A BSS may operate in the presence of one or more overlapping BSS, or OBSS, communications. Transmissions within the OBSS may interfere with operations of the BSS. Thus, methods for mitigating the effects of such interference are desirable.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method may be performed by an apparatus of a wireless communication device, and may include detecting an overlapping basic service set (OBSS) packet transmitted by a second wireless device in an OBSS, decoding one or more signal fields of the OBSS packet, determining that the OBSS packet is a transmission in which one or more resource units (RUs) are unallocated based on the one or more decoded signal fields of the OBSS packet, and performing a spatial reuse (SR) transmission to one or more first stations using a selected number of the unallocated RUs. In some implementations, the method may also include transmitting a multi-user block acknowledgment request (MU-BAR) to the one or more first stations following completion of the SR transmission, and subsequently receiving an acknowledgment from each of the one or more first stations.

In some implementations, decoding the one or more signal fields of the OBSS packet may include decoding a high-efficiency (HE) signal field of the OBSS packet, and the method may also include determining that the OBSS packet is a downlink (DL) orthogonal frequency-division multiple access (OFDMA) transmission to one or more second stations associated with the second wireless device based on the decoded HE signal field. In some aspects, the selection of the number of unallocated RUs may be based at least in part on minimizing inter-RU interference with one or more allocated RUs of the OBSS packet. In addition, or in the alternative, the selection of the number of unallocated RUs may be based at least in part on maximizing a number of tones separating the selected number of unallocated RUs from the one or more allocated RUs.

In some implementations, the SR transmission may be configured to solicit a block acknowledgment (BA) from the one or more first stations, the OBSS packet may be configured to solicit a BA from each of one or more second stations, and the method may further include receiving a BA from each of the one or more first stations after completion of the SR transmission. In some aspects, the SR transmission includes a physical layer convergence protocol (PLCP) protocol data unit (PPDU) containing an embedded trigger that allocates the selected number of unallocated RUs to the one or more first stations for transmitting the BAs as trigger-based (TB) PPDUs.

Another innovative aspect of the subject matter described in this disclosure can be implemented in a wireless communication device. The wireless communication device may include at least one modem, at least one processor communicatively coupled with the at least one modem, and at least one memory communicatively coupled with the at least one processor and storing processor-readable code that, when executed by the at least one processor in conjunction with the at least one modem, is configured to perform operations. In some implementations, the operations may include detecting an overlapping basic service set (OBSS) packet transmitted by a second wireless device in an OBSS, decoding one or more signal fields of the OBSS packet, determining that the OBSS packet is a transmission in which one or more resource units (RUs) are unallocated based on the one or more decoded signal fields of the OBSS packet, and performing a spatial reuse (SR) transmission to one or more first stations using a selected number of the unallocated RUs. In some implementations, the operations may also include transmitting a multi-user block acknowledgment request (MU-BAR) to the one or more first stations following completion of the SR transmission, and subsequently receiving an acknowledgment from each of the one or more first stations.

In some implementations, decoding the one or more signal fields of the OBSS packet may include decoding a high-efficiency (HE) signal field of the OBSS packet, and the operations may also include determining that the OBSS packet is a downlink (DL) orthogonal frequency-division multiple access (OFDMA) transmission to one or more second stations associated with the second wireless device based on the decoded HE signal field. In some aspects, the selection of the number of unallocated RUs may be based at least in part on minimizing inter-RU interference with one or more allocated RUs of the OBSS packet. In addition, or in the alternative, the selection of the number of unallocated RUs may be based at least in part on maximizing a number of tones separating the selected number of unallocated RUs from the one or more allocated RUs.

In some implementations, the SR transmission may be configured to solicit a block acknowledgment (BA) from the one or more first stations, the OBSS packet may be configured to solicit a BA from each of one or more second stations, and the operations may further include receiving a BA from each of the one or more first stations after completion of the SR transmission. In some aspects, the SR transmission includes a physical layer convergence protocol (PLCP) protocol data unit (PPDU) containing an embedded trigger that allocates the selected number of unallocated RUs to the one or more first stations for transmitting the BAs as trigger-based (TB) PPDUs.

Another innovative aspect of the subject matter described in this disclosure can be implemented in a non-transitory computer readable storage medium. The non-transitory computer readable storage medium may store instructions that, when executed by one or more processors of a wireless communication device, cause the wireless communication device to perform operations. In some implementations, the operations may include detecting an overlapping basic service set (OBSS) packet transmitted by a second wireless device in an OBSS, decoding one or more signal fields of the OBSS packet, determining that the OBSS packet is a transmission in which one or more resource units (RUs) are unallocated based on the one or more decoded signal fields of the OBSS packet, and performing a spatial reuse (SR) transmission to one or more first stations using a selected number of the unallocated RUs. In some implementations, the operations may also include transmitting a multi-user block acknowledgment request (MU-BAR) to the one or more first stations following completion of the SR transmission, and subsequently receiving an acknowledgment from each of the one or more first stations.

In some implementations, decoding the one or more signal fields of the OBSS packet may include decoding a high-efficiency (HE) signal field of the OBSS packet, and the operations may also include determining that the OBSS packet is a downlink (DL) orthogonal frequency-division multiple access (OFDMA) transmission to one or more second stations associated with the second wireless device based on the decoded HE signal field. In some aspects, the selection of the number of unallocated RUs may be based at least in part on minimizing inter-RU interference with one or more allocated RUs of the OBSS packet. In addition, or in the alternative, the selection of the number of unallocated RUs may be based at least in part on maximizing a number of tones separating the selected number of unallocated RUs from the one or more allocated RUs.

In some implementations, the SR transmission may be configured to solicit a block acknowledgment (BA) from the one or more first stations, the OBSS packet may be configured to solicit a BA from each of one or more second stations, and the operations may further include receiving a BA from each of the one or more first stations after completion of the SR transmission. In some aspects, the SR transmission includes a physical layer convergence protocol (PLCP) protocol data unit (PPDU) containing an embedded trigger that allocates the selected number of unallocated RUs to the one or more first stations for transmitting the BAs as trigger-based (TB) PPDUs.

Another innovative aspect of the subject matter described in this disclosure can be implemented in a wireless communication device. The wireless communication device may include means for detecting an overlapping basic service set (OBSS) packet transmitted by a second wireless device in an OBSS, means for decoding one or more signal fields of the OBSS packet, means for determining that the OBSS packet is a transmission in which one or more resource units (RUs) are unallocated based on the one or more decoded signal fields of the OBSS packet, and means for performing a spatial reuse (SR) transmission to one or more first stations using a selected number of the unallocated RUs. In some implementations, the wireless communication device may also include means for transmitting a multi-user block acknowledgment request (MU-BAR) to the one or more first stations following completion of the SR transmission, and means for subsequently receiving an acknowledgment from each of the one or more first stations.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 shows a pictorial diagram of an example wireless communication network.

FIG. 2 shows an example wireless system within which the example implementations may be performed.

FIG. 3 shows a block diagram of an example access point (AP), according to some implementations.

FIG. 4 shows an example physical layer convergence protocol (PLCP) protocol data unit (PPDU) usable for communications between an AP and a number of STAs.

FIG. 5 shows a timing diagram illustrating the transmissions of communications according to some implementations.

FIG. 6 shows a flowchart illustrating an example process for wireless communication according to some implementations.

FIG. 7 shows a flowchart illustrating an example process for wireless communication according to some implementations.

FIG. 8 shows a block diagram of an example wireless device according to some implementations.

FIG. 9 shows a block diagram of another example wireless device according to some implementations.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, or 5G (New Radio (NR)) standards promulgated by the 3rd Generation Partnership Project (3GPP), among others. The described implementations can be implemented in any device, system, or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO), and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to improving spatial reuse (SR) in the presence of detected transmissions from an overlapping BSS (OBSS). Some implementations more specifically relate to performing SR in the presence of OFDMA transmissions having partial bandwidth allocations. Further implementations relate more specifically to APs compressing resource unit (RU) allocations for downlink (DL) OFDMA transmissions in order to increase the duration of its DL transmission while and reduce the bandwidth used in such transmissions. Such compressions may allow for increased throughput in the presence of overlapping BSSs (OBSSs) capable of performing SR in the presence of OFDMA transmissions having partial bandwidth allocations.

In some implementations, a first wireless device may detect an overlapping basic service set (OBSS) packet transmitted by a second wireless device in an OBSS. The first wireless device may decode one or more signal fields of the OBSS packet to determine that the OBSS packet is a transmission in which one or more resource units (RUs) are unallocated. The first wireless device may then perform a spatial reuse (SR) transmission to one or more first stations using a selected one or more of the unallocated RUs.

In other implementations, an AP of a first BSS may determine a presence of data for one or more STAs of the first BSS for transmission by a downlink (DL) OFDMA transmission. The AP may compress an RU allocation of the DL OFDMA transmission, wherein the compressed DL OFDMA transmission has at least one unallocated RU and retains at least a threshold bandwidth allocation. The AP may then transmit the DL OFDMA transmission to the one or more STAs in the first BSS.

Particular implementations of the subject matter described in this disclosure can be implemented to realize one or more of the following potential advantages. By performing the SR transmission over one or more unallocated RUs, interference with the OBSS transmission is reduced, improving performance and coexistence of the first BSS and the OBSS. Further, while the preamble of the SR transmission may be required to be transmitted at a power level low enough to meet standard OBSS PD criteria, the power level at which the data of the SR transmission is transmitted—the HE-MU portion of the PPDU—may be transmitted at an increased power level as compared with the preamble, as it is transmitted over unallocated RUs of the OBSS transmission. This may improve reception of the SR transmission.

In addition, the ability for an AP in a first BSS to compress the RU allocation of an DL OFDMA transmission in order to transmit with one or more RUs unallocated may improve overall network throughput while allowing APs in an OBSS to efficiently perform SR transmissions using the unallocated RUs.

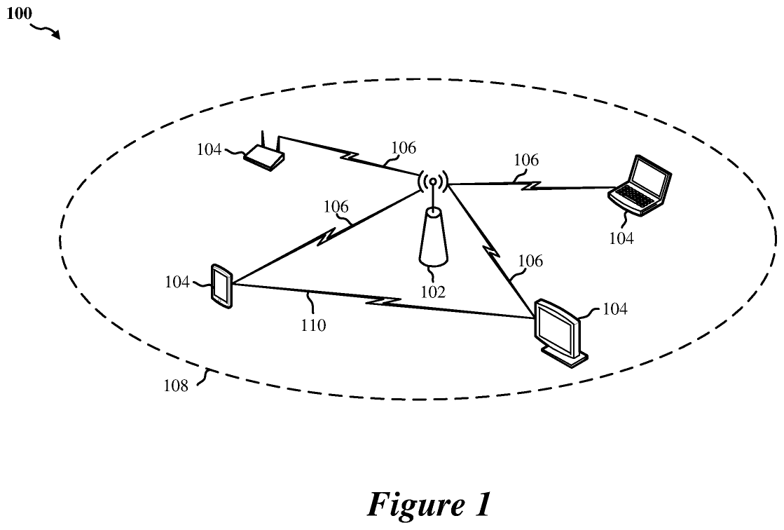

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba, and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistants (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba, and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, or 320 MHz by bonding together multiple 20 MHz channels.

Each PPDU is a composite structure that includes a PHY preamble and a payload in the form of a PLCP service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control, and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from the corresponding STAs 104 to the AP 102). To support the MU transmissions, the APs 102 and the STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including a number of different frequency subcarriers (“tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52-tone, 106-tone, 242-tone, 484-tone, and 996-tone RUs also may be allocated. Adjacent RUs may be separated by a null subcarrier (such as a DC subcarrier), for example, to reduce interference between adjacent RUs, to reduce receiver DC offset, and to avoid transmit center frequency leakage. In some implementations, as discussed further below, not every RU may be allocated to a STA. Such RUs may be referred to as “unallocated RUs.”

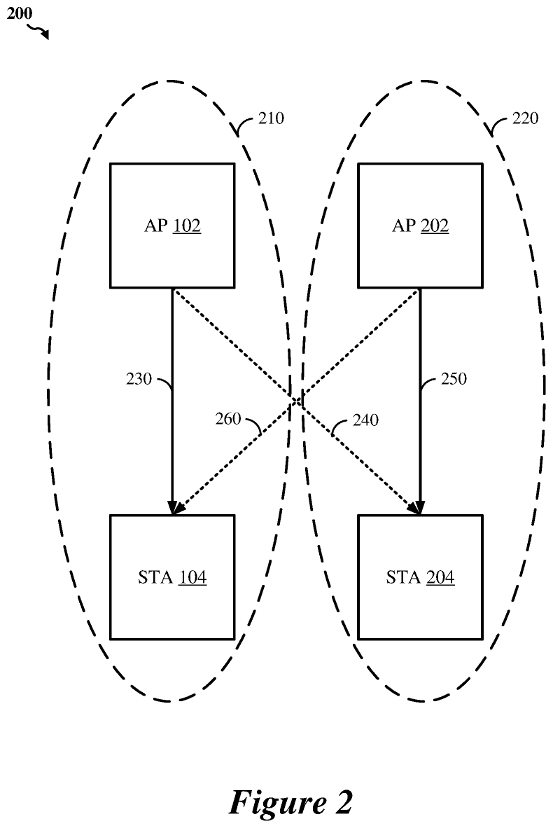

FIG. 2 shows an example wireless system 200 within which the example implementations may be performed. The wireless system 200 may include a first BSS 210 and a second BSS 220. The first BSS 210 may include at least an AP 102 and a STA 104, while the second BSS 220 may include at least an AP 202 and a STA 204. The first BSS 210 and the second BSS 220 may be sufficiently proximate that communications between the AP 102 and the STA 104 may cause interference with communications between the AP 202 and the STA 204. Thus, the first BSS 210 may consider the second BSS 220 to be an OBSS, and the second BSS 220 may consider the first BSS 210 to be an OBSS. Example interference between the first BSS 210 and the second BSS 220 may result from a first transmission 230 from the AP 102 to the STA 104. The STA 204 may receive first OBSS interference signal 240 resulting from the first transmission 230. Similarly, a second transmission 250 from the AP 202 to the STA 204 may cause the STA 104 to receive second OBSS interference signal 260 resulting from the second transmission 250.

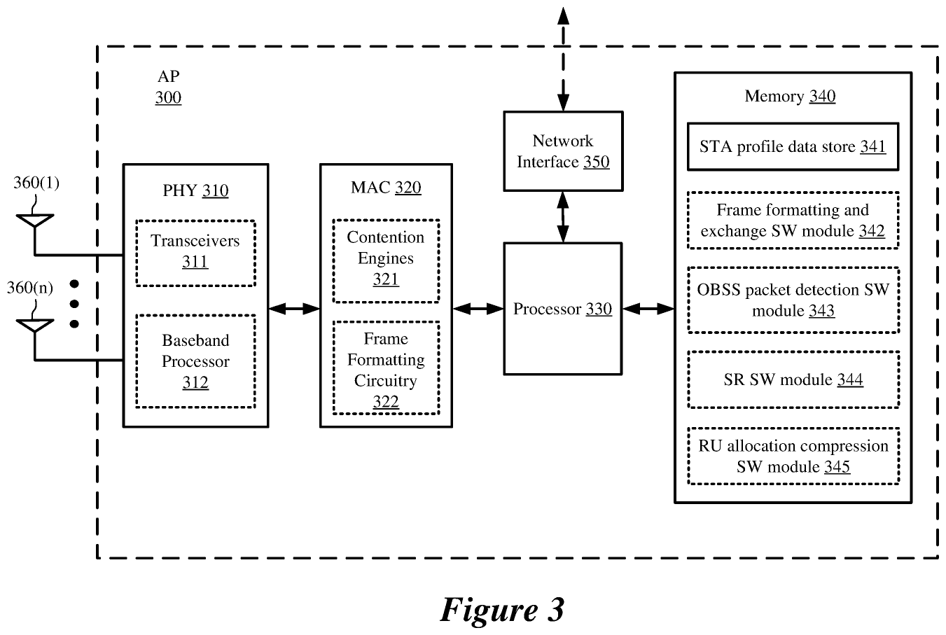

FIG. 3 shows an example AP 300 that may be one embodiment of one or more of the APs 102 and 202 of FIGS. 1-2. AP 300 may include a PHY device 310 including at least a transceiver 311 and a baseband processor 312, may include a MAC 320 including at least a number of contention engines 321 and frame formatting circuitry 322, may include a processor 330, may include a memory 340, may include a network interface 350, and may include a number of antennas 360(1)-360(n). The transceiver 311 may be coupled to antennas 360(1)-360(n), either directly or through an antenna selection circuit (not shown for simplicity). The transceiver 311 may be used to communicate wirelessly with one or more STAs, with one or more other APs, and/or with other suitable devices. Although not shown in FIG. 3 for simplicity, the transceiver 311 may include any number of transmit chains to process and transmit signals to other wireless devices via antennas 360(1)-360(n) and may include any number of receive chains to process signals received from antennas 360(1)-360(n). Thus, for example embodiments, the AP 300 may be configured for MIMO operations including, for example, SU-MIMO operations and MU-MIMO operations.

The baseband processor 312 may be used to process signals received from processor 330 and/or memory 340 and to forward the processed signals to transceiver 311 for transmission via one or more of antennas 360(1)-360(n), and may be used to process signals received from one or more of antennas 360(1)-360(n) via transceiver 311 and to forward the processed signals to processor 330 and/or memory 340.

The network interface 350 may be used to communicate with one or more network devices either directly or via one or more intervening networks and to transmit signals.

Processor 330, which is coupled to PHY device 310, to MAC 320, to memory 340, and to network interface 350, may be any suitable one or more processors capable of executing scripts or instructions of one or more software programs stored in AP 300 (e.g., within memory 340). For purposes of discussion herein, MAC 320 is shown in FIG. 3 as being coupled between PHY device 310 and processor 330. For actual embodiments, PHY device 310, MAC 320, processor 330, memory 340, and/or network interface 350 may be connected together using one or more buses (not shown for simplicity).

The contention engines 321 may contend for access to the shared wireless medium and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330) and may be used to re-format frames received from PHY device 310 (e.g., by stripping MAC headers from frames received from PHY device 310).

Memory 340 may include a STA profile data store 341 that stores profile information for a plurality of STAs. The profile information for a particular STA may include information including, for example, its MAC address, previous AP-initiated channel sounding requests, supported data rates, connection history with AP 300, and any other suitable information pertaining to or describing the operation of the STA.

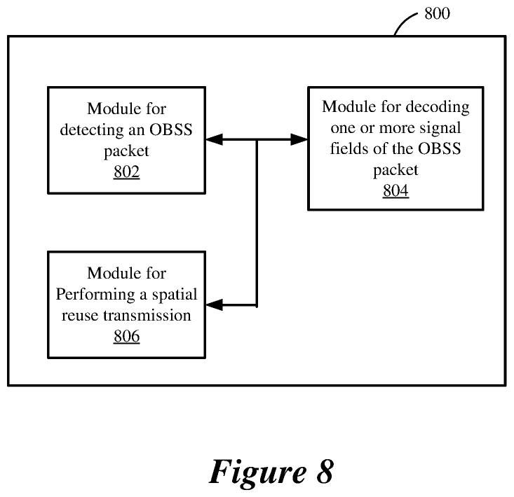

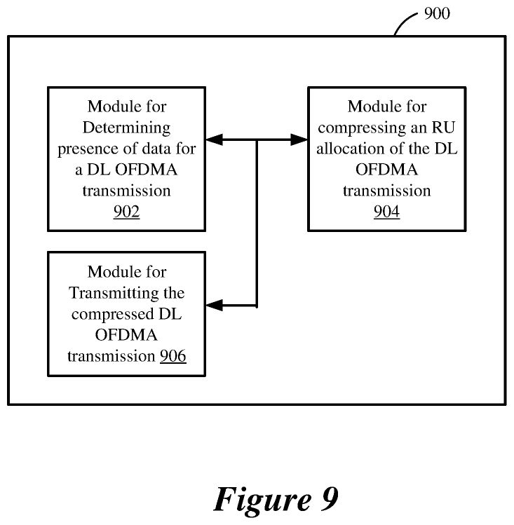

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 for facilitating the creation and exchange of any suitable frames (e.g., probe responses, NDPs, NDPAs, data frames, ACK frames, management frames, action frames, control frames, association responses, beacon frames, and so on) between the AP 300 and other wireless devices such as one or more STAs belonging to the same BSS as the AP 300 (e.g., as described for one or more operations of FIGS. 8-9);
an OBSS packet detection software module 343 for decoding a received packet, detecting that a decoded packet is a DL OFDMA transmission sent by an AP in an OBSS and determining that the DL OFDMA transmission has one or more unallocated RUs (e.g., as described for one or more operations of FIGS. 8-9);
a spectral reuse (SR) software module 344 for generating and transmitting an SR transmission using one or more unallocated RUs of a detected DL OFDMA transmission from an OBSS (e.g., as described for one or more operations of FIGS. 8-9); and
an RU allocation compression software module 345 for generating a compressed RU allocation DL OFDMA transmission for transmission to one or more target stations (e.g., as discussed for one or more operations of FIG. 9).

Each software module includes instructions that, when executed by processor 330, cause AP 300 to perform the corresponding functions. The non-transitory computer-readable medium of memory 340 thus includes instructions for performing all or a portion of the AP-side operations depicted in FIGS. 8-9.

Processor 330, which is shown in the example of FIG. 3 as coupled to transceiver 311 of PHY device 310 via MAC 320, to memory 340, and to network interface 350, may be any suitable one or more processors capable of executing scripts or instructions of one or more software programs stored in AP 300 (e.g., within memory 340). For example, processor 330 may execute the frame formatting and exchange software module 342 to facilitate the creation and exchange of any suitable frames (e.g., probe responses, NDPs, NDPAs, data frames, ACK frames, management frames, action frames, control frames, association responses, beacon frames, and so on) between the AP 300 and other wireless devices such as one or more STAs belonging to the same BSS as the AP 300.

Processor 330 may execute the OBSS packet detection software module 343 to decode a received packet, detect that a decoded packet is a DL OFDMA transmission sent by an AP in an OBSS and determining that the DL OFDMA transmission has one or more unallocated RUs. Processor 330 may execute the spectral reuse (SR) software module 344 to generate and transmit an SR transmission using one or more unallocated RUs of a detected DL OFDMA transmission from an OBSS. Processor 330 may execute the RU allocation compression software module 345 for generating a compressed RU allocation DL OFDMA transmission for transmission to one or more target stations.

As discussed above, transmissions within a BSS may experience interference due to transmissions within a neighboring OBSS. Some conventional techniques may include OBSS packet detection (PD) based spatial reuse (SR). In OBSS PD based SR, a station from a first BSS may detect a packet and determine that it is an OBSS packet from an OBSS, for example by determining that the packet is coded with a BSS color of an OBSS rather than that of the first BSS. The station may consider the channel to be idle if the signal strength (e.g., the received signal strength or RSSI) of the OBSS packet is below an OBSS PD threshold. This determination may be made by comparing a signal strength of a preamble of the OBSS packet to the OBSS PD threshold. Such a threshold may be provided by one or more wireless communications standards, such as an IEEE 802.11ax standard. Thus, the station may transmit even in the presence of the detected OBSS packet, provided that the OBSS packet has an RSSI less than the OBSS PD threshold.

While such OBSS PD based SR transmissions may help to increase channel usage within the first BSS, such SR transmissions may interfere with the reception of signals within the OBSS. For example first and second OBSS interference signals 240 and 260 of FIG. 2. Such interference may adversely affect the throughput of signals transmitted within the OBSS. Further, devices receiving the SR transmissions within the first BSS may also experience interference from ongoing transmissions within the OBSS. Moreover, such interference due to SR transmissions may cause nonlinear changes in the interference levels for each transmission within the first BSS. Such interference may make efficient rate adaptation much more complicated. Accordingly, it would be desirable to provide for SR transmissions which reduce such interference.

Accordingly the example implementations may allow for an AP to perform an SR transmission in the presence of a detected OBSS transmission having one or more unallocated RUs. The SR transmission may have a preamble transmitted using the same spectrum as the OBSS transmission but may have data transmitted over one or more of the unallocated RUs. Accordingly, the SR transmission may avoid interfering with the OBSS transmission, except for the preamble. The example implementations may thus reduce interference between the OBSS transmissions and the SR transmissions.

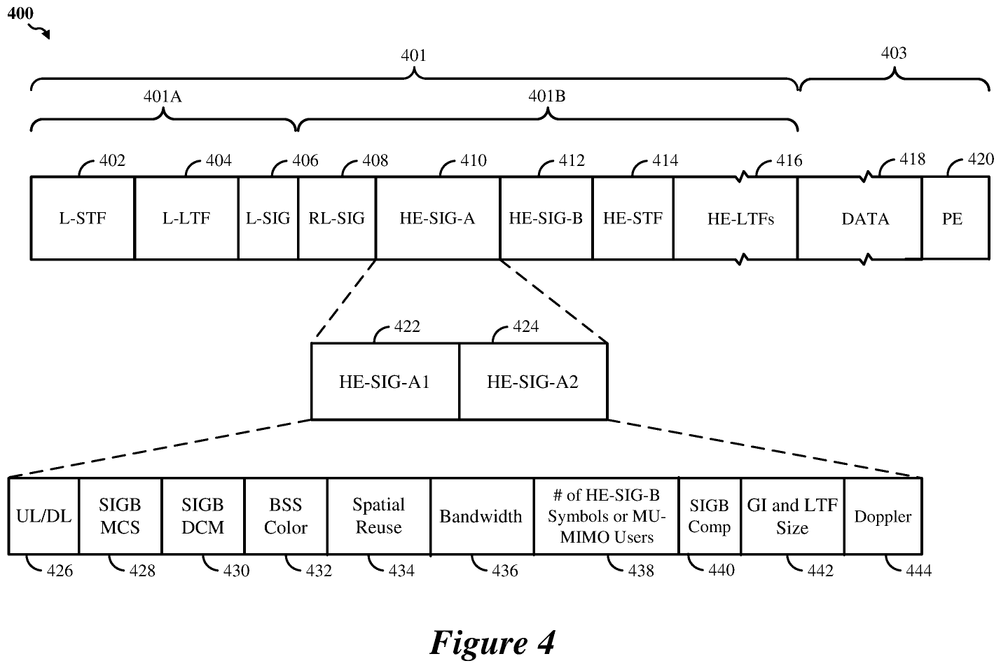

FIG. 4 shows an example PPDU 400 usable for wireless communication between an AP and a number of STAs. The PPDU 400 may be used for MU-OFDMA or MU-MIMO transmissions. As shown, the PDDU 400 includes a PHY preamble 401 and a PHY payload 403. The preamble 401 may include a first portion 401A that includes a legacy short training field (L-STF) 402, which may consist of two BPSK symbols, a legacy long training field (L-LTF) 404, which may consist of two BPSK symbols, and a legacy signal field (L-SIG) 406, which may consist of one BPSK symbol. The first portion 401A of the preamble 401 may be configured according to the IEEE 802.11a wireless communication protocol standard, and may be referred to as the legacy portion of the preamble 401. L-STF 402 generally enables a receiving device to perform automatic gain control (AGC) and coarse timing and frequency estimation. L-LTF 404 generally enables a receiving device to perform fine timing and frequency estimation and also to perform an initial estimate of the wireless channel. L-SIG 406 generally enables a receiving device to determine a duration of the PPDU and to use the determined duration to avoid transmitting on top of the PPDU. For example, L-STF 402, L-LTF 404, and L-SIG 406 may be modulated according to a binary phase shift keying (BPSK) modulation scheme.

The preamble 401 may also include a second portion 401B including one or more non-legacy signal fields, for example, conforming to an IEEE wireless communication protocol such as the IEEE 802.11ac, 802.11ax, 802.11be or later wireless communication protocol standards. The second portion 401B may be referred to as the non-legacy portion of the preamble 401. The non-legacy portion 401B includes a repeated legacy signal field (RL-SIG) 408, a first HE signal field (HE-SIG-A) 410, a second HE signal field (HE-SIG-B) 412 encoded separately from HE-SIG-A 410, an HE short training field (HE-STF) 414, a number of HE long training fields (HE-LTFs) 416, the data field 418 and packet extension (PE) field 420. Like the L-STF 402, L-LTF 404, and L-SIG 406, the information in RL-SIG 408 and HE-SIG-A 410 may be duplicated and transmitted in each of the component 20 MHz channels in instances involving the use of a bonded channel. In contrast, HE-SIG-B 412 may be unique to each 20 MHz channel and may target specific STAs 104.

RL-SIG 408 may indicate to HE-compatible STAs 104 that the PPDU is an HE PPDU. An AP 102 may use HE-SIG-A 410 to identify and inform multiple STAs 104 that the AP has scheduled UL or DL resources for them. HE-SIG-A 410 may be decoded by each HE-compatible STA 104 served by the AP 102. HE-SIG-A 410 includes information usable by each identified STA 104 to decode an associated HE-SIG-B 412. For example, HE-SIG-A 410 may indicate the frame format, including locations and lengths of HE-SIG-Bs 412, available channel bandwidths, modulation and coding schemes (MCSs), among other possibilities. HE-SIG-A 410 also may include HE WLAN signaling information usable by STAs 104 other than the number of identified STAs 104.

HE-SIG-B 412 may carry STA-specific scheduling information such as, for example, per-user MCS values and per-user RU allocation information. In the context of DL MU-OFDMA, such information enables the respective STAs 104 to identify and decode corresponding RUs in the associated data field. Each HE-SIG-B 412 includes a common field and at least one STA-specific (“user-specific”) field. The common field can indicate RU distributions to multiple STAs 104, indicate the RU assignments in the frequency domain, indicate which RUs are allocated for MU-MIMO transmissions and which RUs correspond to MU-OFDMA transmissions, and the number of users in allocations, among other possibilities. The common field may be encoded with common bits, CRC bits, and tail bits. The user-specific fields are assigned to particular STAs 104 and may be used to schedule specific RUs and to indicate the scheduling to other WLAN devices. Each user-specific field may include multiple user block fields (which may be followed by padding). Each user block field may include two user fields that contain information for two respective STAs to decode their respective RU payloads in DATA field 418. Further, each user block field may indicate that an associated RU is unallocated, that is, that the associated RU of the RU distribution is not allocated to one of the STAs 104. In some implementations, such an unallocated RU may be denoted by a user block having a predetermined value in its station identification field. In some implementations, this predetermined value may be 2046 in a STA-ID field of the user block field.

The HE-SIG-A field 410 may itself contain two subfields, HE-SIG-A1 422 and HE-SIG-A2 424. The HE SIG-A1 subfield 422 may include an UL/DL subfield 426 indicating whether the PPDU 400 is sent UL or DL. The HE-SIG-A1 subfield 422 may further include a SIGB-MCS subfield 428 indicating the MCS for the HE-SIGB field 412. The HE-SIG-A1 subfield 422 may further include a SIGB DCM subfield 430 indicating whether or not the HE-SIG-B field 412 is modulated with dual carrier modulation (DCM). The HE-SIG-A1 subfield 422 may further include a BSS color field 432 indicating a BSS color identifying the BSS. Each device in a BSS may identify itself with the same BSS color. Thus, receiving a transmission having a different BSS color indicates the transmission is from another BSS, such as an OBSS.

The HE-SIG-A1 subfield 422 may further include a spatial reuse subfield 434 indicating whether spatial reuse is allowed during transmission of the PPDU 400. The HE-SIG-A1 subfield 422 may further include a bandwidth subfield 436 indicating a bandwidth of the data field 418, such as 20 MHz, 40 MHz, 80 MHz, 160 MHz, and so on. The HE-SIG-A1 subfield 422 may further include a number of HE-SIG-B symbols or MU-MIMO users subfield 438 indicating either a number of OFDM symbols in the HE-SIG-B field 412 or a number of MU-MIMO users. The HE-SIG-A1 subfield 422 may further include a SIGB compression subfield 440 indicating whether or not the common field of the HE-SIG-B field 412 is present. The HE-SIG-A1 subfield 422 may further include a GI+LTF size subfield 442 indicating the guard interval (GI) duration and the size of the HE-LTFs 416. The HE-SIG-A1 subfield 422 may further include a doppler subfield 444 indicating whether a number of OFDM symbols in data field 418 is larger than a signaled midamble periodicity plus one, and the midamble is present, or that the number of OFDM symbols in data field 418 is less than or equal to the signaled midamble periodicity plus 1, that the midamble is not present, but that the channel is fast varying.

The PPDU payload 403 follows the preamble 401, for example, in the form of a PSDU including a DATA field 418. The payload 403 may be modulated according to a BPSK modulation scheme, a quadrature BPSK (Q-BPSK) modulation scheme, a quadrature amplitude modulation (QAM) modulation scheme, or another appropriate modulation scheme. The data field 418 may carry higher layer data, for example, in the form of medium access control (MAC) protocol data units (MPDUs) or an aggregated MPDU (A-MPDU). In some implementations, the non-legacy portion of the preamble and the DATA field 418 may be formatted as a High Efficiency (HE) WLAN preamble and frame, respectively, in accordance with the IEEE 802.11ax amendment to the IEEE 802.11 wireless communication protocol standard.

While the PPDU 400 is depicted as an HE PPDU, in some other aspects, a PPDU for use with the example implementations may be formatted as an Extreme High Throughput (EHT) WLAN PPDU in accordance with the IEEE 802.11be amendment to the IEEE 802.11 wireless communication protocol standard, or may be formatted as a PPDU conforming to any later (post EHT) version of a new wireless communication protocol conforming to a future IEEE 802.11 wireless communication protocol standard or another wireless communication standard. For implementations where the PPDU is an EHT PPDU, RU allocation and BSS identification information, such as BSS color information, may be included in one or more signal fields of the EHT PPDU, such as an EHT-SIG field, a universal signal (U-SIG) field of the EHT PPDU. For implementations where the PPDU 400 is a post-EHT PPDU, the RU allocation and BSS identification information may be included in one or more fields, such as one or more signal fields, of the post-EHT PPDU. Thus, a wireless communication device according to some example implementations may decode one or more of these signal fields, such as the EHT-SIG field, the U-SIG field, or a signal field in a post-EHT PPDU, in order to determine that the received PPDU is from an OBSS, and whether or not one or more RUs in the PPDU are unallocated.

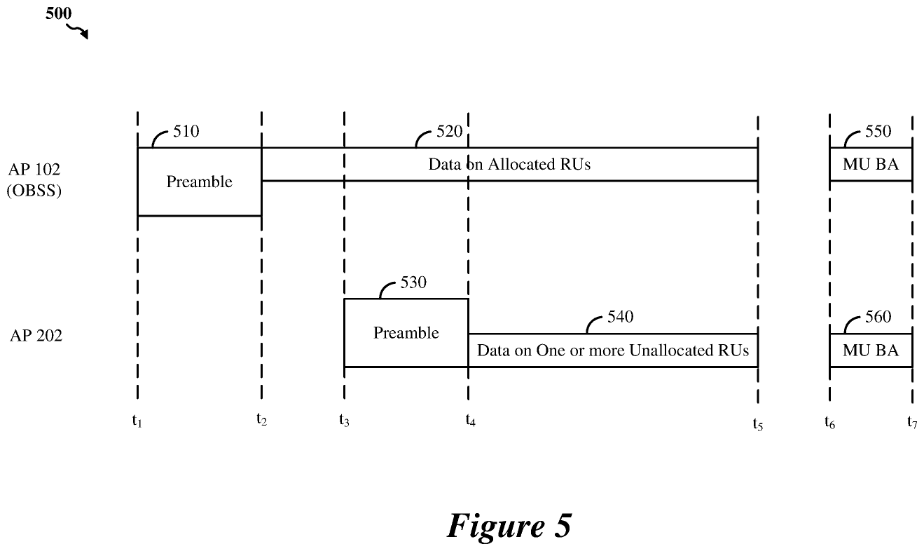

As discussed above, the example implementations may allow an AP to perform an SR transmission in the presence of a detected OBSS transmission having one or more unallocated RUs by transmitting the SR transmission via one or more of the unallocated RUs. FIG. 5 shows an example timing diagram 500 of an SR transmission according to some implementations. With respect to FIG. 5, between times t₁ and t₂, the AP 102 may transmit a preamble 510 marking the start of a transmission to one or more stations of an OBSS. The AP 202 may detect the transmission of the preamble 510 and may decode it to determine relevant information about the transmission from the AP 102, such as determining that the transmission is a DL OFDMA transmission. Further, the AP 202 may determine that the transmission from the AP 102 is an OBSS transmission, for example, by detecting that the BSS color indicated in one or more signal fields of the preamble 510 is different from the BSS color of the BSS to which the AP 202 belongs. Such a signal field may be a BSS color subfield such as BSS color subfield 432 of HE-SIG-A1 subfield 422 of the HE-SIG-A field 410 of PPDU 400 of FIG. 4. Further, the AP 202 may determine that spatial reuse is allowed, for example, by consulting spatial reuse subfield 433. Additionally, the AP 202 may determine the RU distribution, and that one or more RUs of the transmission from the AP 102 are unallocated, for example, by examining the common and user-specific fields of HE-SIG-B field 412 of FIG. 4.

At time t₂, the AP 102 begins transmission of the data 520 to one or more stations in the OBSS to which the AP 102 belongs. Note that while the preamble 510 was transmitted using a full bandwidth signal, the data 520 is transmitted using frequency bands assigned to the allocated RUs, for example, such that unallocated RUs are not used.

After determining that the transmission from the AP 102 is a DL OFDMA transmission having one or more unallocated RUs, the AP 202 determines to perform a SR transmission, such as transmission of an HE MU PPDU using one or more of the unallocated RUs. Thus, at time t₃, the AP 202 begins transmission of preamble 530 of the SR transmission. Similarly to the preamble 510, the preamble 530 is transmitted using a full bandwidth signal. Consequently, the power level of the preamble 530 may be required to be below a predetermined maximum value, such as below a threshold corresponding to an OBSS PD threshold. At time t₄, AP 202 begins transmitting the data 540 via one or more RUs determined to be unallocated for transmission of the data 520. In some implementations, the data 540 may also be transmitted at a power level which is below the predetermined maximum value. In other implementations, the data 540 may be transmitted at a higher power level than the preamble 530, as the use of the unallocated RUs may reduce interference at the one or more stations of the OBSS caused by the transmission of the data 540—that is, interference with the reception of the data 520 due to the SR transmission from the AP 202.

The transmission of data 540 may be selected to have a duration whose end coincides with a duration for transmission of the data 520. Thus, both transmission of data 520 and transmission of data 540 may end at time t₅.

In some implementations, the transmission from AB 102 and the transmission from AP 202 may each solicit a block acknowledgment (BA) from each station receiving the respective transmission. In some implementations, the BAs may be solicited in a trigger-based PPDU (TB PPDU) format. This solicitation may be based on a trigger embedded in the respective PPDUs sent by the AP 102 and the AP 202. Thus, at a specified time after completion of the data transmissions each receiving station may respond with a MU BA, shown in FIG. 5 as transmitted between timed t₆ and t₇, where stations receiving the data 520 respond with MU BA 550, and stations receiving the data 540 respond with MU BA 560.

In some other implementations (not shown in FIG. 5 for simplicity), other methods for acknowledgment of the transmissions may be used. For example, the AP 102 and AP 202 may agree on the format for acknowledgments with regard to SR transmissions. For example, a specified one of the AP 102 and 202 may transmit a MU BA request (MU-BAR) first, requesting that the corresponding stations simultaneously response with an acknowledgment. Then, the other of the AP 102 and 202 may transmit its MU-BAR, and its receiving stations may simultaneously respond with acknowledgment. Alternatively, acknowledgments may be individually requested from each station, with a specified one of the AP 102 and the AP 202 requesting acknowledgments first. In such implementations, the first acknowledgement may be sent without request, and the AP 102, the AP 202, and the corresponding stations of each BSS may agree in advance on which station of which BSS is to respond first. In some other implementations, each acknowledgment may be individually requested, and the AP 102 and AP 202 may agree in advance on the order in which the AP 102 and AP 202 request acknowledgments—for example, whether the AP 102 or the AP 202 is to request its acknowledgements first.

As described above, example implementations may allow an AP to perform an SR transmission over one or more unallocated RUs of a detected OBSS transmission. For example, such unallocated RUs may include one or more of a 26 tone RU, a 52 ltone RU, a 106 tone RU (including 4 pilot tones), and a 245 tone RU (including 3 DC tones), each of which may be available in differing numbers depending on the bandwidth of the MU PPDU (e.g., 20 MHz, 40 MHz, 80 MHz, 160 MHz). When only one RU is unallocated, selection of which RU the SR transmission should use is straightforward, however, when multiple RUs are unallocated, RUs may be selected in an order to minimize inter-RU interference. In some implementations, the one or more RUs for the SR transmission may be selected to maximize a number of tones separating the selected one or more RUs from the RUs allocated for use by the OBSS transmission. For example, when the OBSS transmission is a 20 MHz MU PPDU including 9 26 tone RUs, some RUs are immediately adjacent to another RU, while other are separated by a null tone. Given a choice, RUs may preferably be selected for the SR transmission which are adjacent the null tones rather than immediately adjacent another RU. Similarly, when the OBSS transmission is an 80 MHz MU PPDU including 8 106 tone RUs, some of the 106 tone RUs are separated only by 2 null tones, while others are separated by 2 null tones and a 26 tone RU. Given a choice, RUs may preferably be selected for the SR transmission which are adjacent the 2 null tones and the 26 tone RU rather than an RU which is only separated by the two null tones from the next adjacent 106 tone RU. Selecting RUs for the SR transmission which maximize the number of tones separating selected RUs from the RUs allocated by the OBSS transmission may decrease the interference between the OBSS transmission and the SR transmission.

The above implementations have been described in terms of an AP detecting an OBSS transmission having unallocated RUs and performing an SR transmission using one or more of the unallocated RUs. However, in some other implementations, an AP of a first BSS may be configured to form transmit MU OFDMA PPDUs which preferentially include one or more unallocated RUs, to improve coexistence with one or more OBSSs near the first BSS and improve throughput of the network.

Transmission of small packets can reduce network efficiency, due to the large overhead to data ratio. MU OFDMA transmissions may improve network throughput when multiple small packets of information are collected into a single MU transmission. Consequently, in a network environment where multiple nearby BSSs are capable of SR transmissions using unallocated RUs, as discussed above, it may be desirable for an AP to perform MU OFDMA transmissions including one or more unallocated RUs. Transmitting with one or more unallocated RUs may allow one or more nearby APs of OBSSs to perform SR transmissions, thereby improving overall network throughput.

Accordingly, in some implementations, an AP may compress an RU allocation of a planned DL OFDMA transmission in order that at least one RU of the compressed transmission is unallocated. In some implementations the compressed transmission may be configured to maximize a PPDU duration of the DL OFDMA transmission, while maintaining at least a minimum bandwidth allocation. In some implementations, the minimum bandwidth allocation may be a minimum bandwidth allocation allowed in an MU PPDU, for example according to one or more standards, such as the IEEE 802.11 family of standards. Increasing the PPDU duration and compressing the RU allocation may increase the likelihood that a neighboring OBSS may be able to perform an SR transmission using one or more of the unallocated RUs, thus increasing the efficiency and overall network throughput.

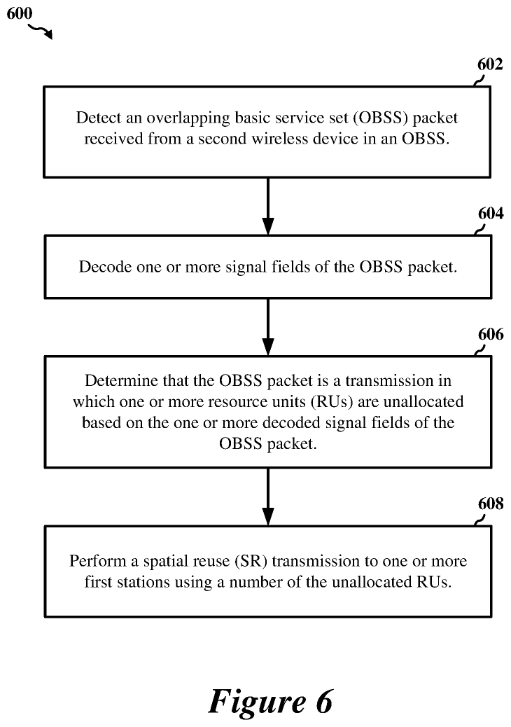

FIG. 6 shows a flowchart illustrating an example process 600 for spatial reuse in a wireless network according to some implementations. The process 600 may be performed by a first wireless device such as the AP 102 described above with reference to FIG. 1, the AP 102 or AP 202 described above with respect to FIG. 2, or the AP 300 described above with respect to FIG. 3.

In some implementations, in block 602, the first wireless device detects an overlapping basic service set (OBSS) packet received from a second wireless device in an OBSS. In block 604, the first wireless device decodes one or more signal fields of the OBSS packet. In block 606, the first wireless device determines that the OBSS packet is a transmission in which one or more resource units (RUs) are unallocated based on the one or more decoded signal fields of the OBSS packet. In block 608, the first wireless device performs a spatial reuse (SR) transmission to one or more first stations using a number of the unallocated RUs.

In some implementations, decoding the one or more signal fields of the OBSS packet in block 604 includes decoding a high efficiency (HE) signal field of the OBSS packet to determine that the OBSS packet is a downlink (DL) orthogonal frequency-division multiple access (OFDMA) transmission to one or more second stations associated with the second wireless device. In some implementations, performing the SR transmission further includes waiting for a HE physical layer (PHY) preamble of the DL OFDMA transmission to finish before performing the SR transmission.

In some implementations, decoding the one or more signal fields of the OBSS packet in block 604 includes identifying a BSS color of the OBSS packet based at least in part on the one or more signal fields and determining that the OBSS packet is from the OBSS based at least in part on the BSS color.

In some implementations, the number of unallocated RUs in block 606 may be selected to minimize inter-RU interference with one or more allocated RUs of the OBSS packet. In addition, or in the alternative, the number of unallocated RUs may be selected to maximize a number of tones separating the selected one or more of the unallocated tones from the one or more allocated RUs.

In some implementations, performing the SR transmission in block 608 includes selecting a duration for the SR transmission to coincide with an end of the OBSS packet's transmission.

In some implementations, the SR transmission includes a preamble and a payload, where the preamble and the payload of the SR transmission are transmitted at different power levels. In some aspects, the preamble of the SR transmission is transmitted at power level that does not exceed a threshold power level, which may correspond to an OBSS packet detection (PD) power level threshold.

In some implementations, the SR transmission solicits a block acknowledgment (BA) from each of the one or more first stations, the OBSS packet solicits a BA from each of one or more second stations, and the process 600 further includes receiving a BA from each of the one or more first stations. In some aspects, the SR transmission includes a physical layer convergence protocol (PLCP) protocol data unit (PPDU) containing an embedded trigger that allocates the selected number of unallocated RUs to the one or more first stations for transmitting the BAs as trigger-based (TB) PPDUs.

In some implementations, the process 600 further includes transmitting a multi-user block acknowledgment request (MU-BAR) to the one or more first stations following completion of the SR transmission, and subsequently receiving an acknowledgment from each of the one or more first stations.

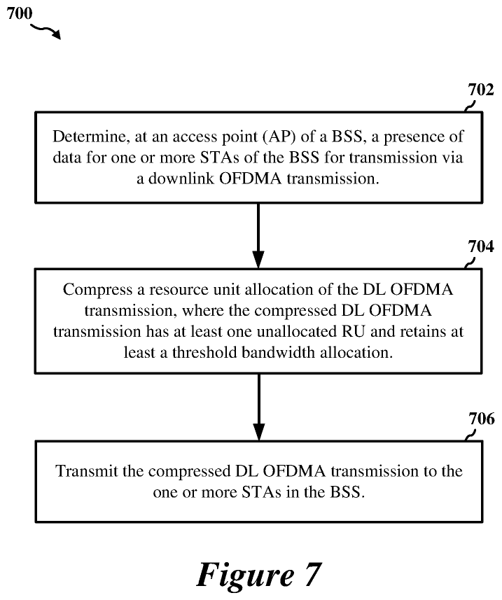

FIG. 7 shows a flowchart illustrating an example process 700 for facilitating spatial reuse in a wireless network according to some implementations. The process 600 may be performed by a wireless device of a BSS, such as the AP 102 described above with reference to FIG. 1, the AP 102 or AP 202 described above with respect to FIG. 2, or the AP 300 described above with respect to FIG. 3.

In some implementations, in block 702 the wireless device determines a presence of data for one or more STAs of the BSS for transmission via a downlink OFDMA transmission. At block 704 the wireless device compresses a resource unit allocation of the DL OFDMA transmission, where the compressed DL OFDMA transmission has at least one unallocated RU and retains at least a threshold bandwidth allocation. At block 706 the wireless device transmits the compressed DL OFDMA transmission to the one or more STAs in the BSS.

FIG. 8 shows a block diagram of an example wireless device 800 according to some implementations. In some implementations, the wireless device 800 is configured to perform one or more of the processes 600 and 700 described above with reference to FIGS. 6 and 7, respectively. The wireless device 800 may be an example implementation of the AP 102 of FIG. 1, AP 102 or AP 202 of FIG. 2, or AP 300 of FIG. 3. For example, the wireless device 800 can be a chip, SoC, chipset, package, or device that includes at least one processor and at least one modem (for example, a Wi-Fi (IEEE 802.11) modem or a cellular modem).

The wireless device 800 includes a module for detecting an OBSS packet 802, a module for decoding one or more signal fields of the OBSS packet 804, and a module for performing a spatial reuse transmission 806. Portions of one or more of the modules 802, 804, and 806 may be implemented at least in part in hardware or firmware. For example, the module for detecting an OBSS packet 802 and the module for performing a spatial reuse transmission 806 may be implemented at least in part by one or more antennas of antennas 360(1)-360(n), PHY 310, or MAC 320. In some implementations, at least some of the modules 802, 804, and 806 are implemented at least in part as software stored in a memory (such as the memory 340). For example, portions of one or more of the modules 802, 804, and 806 can be implemented as non-transitory instructions (or “code”) executable by a processor (such as the processor 330) to perform the functions or operations of the respective module.

FIG. 9 shows a block diagram of an example wireless device 900 according to some implementations. In some implementations, the wireless device 900 is configured to perform one or more of the processes 600 and 700 described above with reference to FIGS. 6 and 7, respectively. The wireless device 900 may be an example implementation of the AP 102 of FIG. 1, AP 102 or AP 202 of FIG. 2, or AP 300 of FIG. 3. For example, the wireless device 900 can be a chip, SoC, chipset, package, or device that includes at least one processor and at least one modem (for example, a Wi-Fi (IEEE 802.11) modem or a cellular modem).

The wireless communication device 900 includes a module for determining a presence of data for a DL OFDMA transmission 902, a module for compressing an RU allocation of the DL OFDMA transmission 904, and a module for transmitting the compressed DL OFDMA transmission 906. Portions of one or more of the modules 902, 904, and 906 may be implemented at least in part in hardware or firmware. For example, the module for transmitting the compressed DL OFDMA transmission 906 may be implemented at least in part by one or more of the antennas 360(1)-360(n), the PHY 310, or the MAC 320. In some implementations, at least some of the modules 902, 904, and 906 are implemented at least in part as software stored in a memory (such as the memory 340). For example, portions of one or more of the modules 902, 904, and 906 can be implemented as non-transitory instructions (or “code”) executable by a processor (such as the processor 330) to perform the functions or operations of the respective module.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The various illustrative components, logic, logical blocks, modules, circuits, operations and algorithm processes described in connection with the implementations disclosed herein may be implemented as a general-purpose processing system with one or more microprocessors providing the processor functionality and external memory providing at least a portion of the machine-readable media, linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for spatial reuse in a wireless network, the method performed by a first wireless device and comprising:
detecting an overlapping basic service set (OBSS) packet received from a second wireless device in an OBSS;
decoding one or more signal fields of the OBSS packet;
determining that the OBSS packet is a transmission in which one or more resource units (RUs) are unallocated based on the one or more decoded signal fields of the OBSS packet; and
performing a spatial reuse (SR) transmission to one or more first stations using a number of the unallocated RUs.

2. The method of claim 1, wherein decoding the one or more signal fields of the OBSS packet comprises decoding a high-efficiency (HE) signal field of the OBSS packet, and the method further comprises determining that the OBSS packet is a downlink (DL) orthogonal frequency-division multiple access (OFDMA) transmission to one or more second stations associated with the second wireless device based on the decoded HE signal field.

3. The method of claim 2, wherein performing the SR transmission further comprises waiting for a HE physical layer (PHY) preamble of the DL OFDMA transmission to finish before performing the SR transmission.

4. The method of claim 1, wherein the number of unallocated RUs are selected based at least in part on minimizing inter-RU interference with one or more allocated RUs of the OBSS packet.

5. The method of claim 4, wherein the selection of the number of unallocated RUs is further based on maximizing a number of tones separating the selected number of unallocated RUs from the one or more allocated RUs.

6. The method of claim 1, wherein performing the SR transmission further comprises selecting a duration for the SR transmission to coincide with an end of the OBSS packet's transmission.

7. The method of claim 1, wherein the SR transmission includes a preamble and a payload, wherein the preamble and the payload of the SR transmission are transmitted at different power levels.

8. The method of claim 7, wherein the preamble of the SR transmission is transmitted at a power level which does not exceed a threshold power level.

9. The method of claim 8, wherein the threshold power level corresponds to an OBSS packet detection (PD) power level threshold.

10. The method of claim 1, wherein the SR transmission is configured to solicit a block acknowledgment (BA) from the one or more first stations, the OBSS packet is configured to solicit a BA from each of one or more second stations, and wherein the method further includes receiving a BA from each of the one or more first stations after completion of the SR transmission.

11. The method of claim 10, wherein the SR transmission comprises a physical layer convergence protocol (PLCP) protocol data unit (PPDU) containing an embedded trigger that allocates the selected number of unallocated RUs to the one or more first stations for transmitting the BAs as trigger-based (TB) PPDUs.

12. The method of claim 1, further comprising:
transmitting a multi-user block acknowledgment request (MU-BAR) to the one or more first stations following completion of the SR transmission; and
subsequently receiving an acknowledgment from each of the one or more first stations.

13. An apparatus for wireless communication, comprising:
a processing system configured to:
detect an overlapping basic service set (OBSS) packet received from a second wireless device in an OBSS;
decode one or more signal fields of the OBSS packet;
determine that the OBSS packet is a transmission in which one or more resource units (RUs) are unallocated based on the one or more decoded signal fields of the OBSS packet; and
a first interface communicatively coupled to the processing system, the first interface configured to output for transmission a spatial reuse (SR) transmission to one or more first stations using a number of the unallocated RUs.

14. The apparatus of claim 13, wherein decoding the one or more signal fields of the OBSS packet comprises:
decoding a high-efficiency (HE) signal field of the OBSS packet; and
determining that the OBSS packet is a downlink (DL) orthogonal frequency-division multiple access (OFDMA) transmission to one or more second stations associated with the second wireless device based on the decoded HE signal field.

15. The apparatus of claim 14, wherein the first interface is further configured to output the SR transmission after waiting for a HE physical layer (PHY) preamble of the DL OFDMA transmission to finish.

16. The apparatus of claim 13, wherein the number of unallocated RUs are selected based at least in part on minimizing inter-RU interference with one or more allocated RUs of the OBSS packet.

17. The wireless communication device of claim 16, wherein the selection of the number of unallocated RUs is further based on maximizing a number of tones separating the selected number of unallocated RUs from the one or more allocated RUs.

18. The wireless communication device of claim 13, wherein outputting the SR transmission further comprises selecting a duration for the SR transmission to coincide with an end of the OBSS packet's transmission.

19. The apparatus of claim 13, wherein the SR transmission includes a preamble and a payload, wherein the preamble and the payload of the SR transmission are transmitted at different power levels.

20. The apparatus of claim 19, wherein the preamble of the SR transmission is transmitted at a power level which does not exceed a threshold power level.

21. The apparatus of claim 20, wherein the threshold power level corresponds to an OBSS packet detection (PD) power level threshold.

22. The apparatus of claim 13, wherein the SR transmission is configured to solicit a block acknowledgment (BA) from the one or more first stations, the OBSS packet is configured to solicit a BA from one or more second stations, and wherein the apparatus further comprises a second interface configured to obtain a BA from each of the one or more first stations after completion of the SR transmission.

23. The apparatus of claim 22, wherein the SR transmission comprises a physical layer convergence protocol (PLCP) protocol data unit (PPDU) containing an embedded trigger that allocates the selected number of unallocated RUs to the one or more first stations for transmitting the BAs as trigger-based (TB) PPDUs.

24. The apparatus of claim 13, wherein the first interface is further configured to:
output for transmission a multi-user block acknowledgment request (MU-BAR) to the one or more first stations following completion of the SR transmission; and
wherein the apparatus further comprises a second interface configured to obtain an acknowledgment from each of the one or more first stations.

25. The apparatus of claim 13, further comprising:
a receiver configured to receive the OBSS packet; and
a transmitter configured to transmit the SR transmission, wherein the apparatus is configured as a wireless node.

26. A non-transitory computer readable storage medium storing instructions that, when executed by one or more processors of a wireless communication device, cause the wireless communication device to perform operations comprising:
detecting an overlapping basic service set (OBSS) packet received from a second wireless device in an OBSS;
decoding one or more signal fields of the OBSS packet;
determining that the OBSS packet is a transmission in which one or more resource units (RUs) are unallocated based on the one or more decoded signal fields of the OBSS packet; and
performing a spatial reuse (SR) transmission to one or more first stations using a number of the unallocated RUs.

27. The non-transitory computer readable storage medium of claim 25, wherein execution of the instructions for decoding the one or more signal fields of the OBSS packet causes the wireless communication device to perform operations further comprising:
decoding a high efficiency (HE) signal field of the OBSS packet; and
determining that the OBSS packet is a downlink (DL) orthogonal frequency-division multiple access (OFDMA) transmission to one or more second stations associated with the second wireless device based on the decoded HE signal field.

28. The non-transitory computer readable storage medium of claim 25, wherein the number of unallocated RUs is selected based at least in part on minimizing inter-RU interference with one or more allocated RUs of the OBSS packet.

29. The non-transitory computer readable storage medium of claim 25, wherein the SR transmission includes a preamble and a payload, wherein the preamble and the payload of the SR transmission are transmitted at different power levels.

30. A wireless communication device comprising:
means for detecting an overlapping basic service set (OBSS) packet received from a second wireless device in an OBSS;
means for decoding one or more signal fields of the OBSS packet;
means for determining that the OBSS packet is a transmission in which one or more resource units (RUs) are unallocated based on the one or more decoded signal fields of the OBSS packet; and
means for performing a spatial reuse (SR) transmission to one or more first stations using a number of the unallocated RUs.
